(19) United States
(12) Patent Application Publication
(10) Pub. No.: US 2019/0132261 A1
(43) Pub. Date: May 2, 2019

(54) LINK LOCKING IN ETHERNET NETWORKS

(71) Applicant: Ciena Corporation, Hanover, MD (US)

(72) Inventors: Prashant VASHISHT, Gurgaon (IN); Rajneesh MISHRA, Gurgaon (IN); Ritesh RALHAN, New Delhi (IN)

(21) Appl. No.: 15/842,998

(22) Filed: Dec. 15, 2017

(30) Foreign Application Priority Data
Nov. 2, 2017 (IN) 201711039130

(51) Int. Cl. H04L 12/939; H04L 12/703; H04L 12/24; H04L 12/707; H04L 12/26

(52) U.S. Cl. CPC H04L 49/55; H04L 45/28; H04L 69/40; H04L 45/22; H04L 43/0817; H04L 41/0663

(57) ABSTRACT

Systems and methods of Ethernet link locking to detect incorrect cabling implemented at a network element include identifying information using Link Layer Discovery Protocol (LLDP) on a port in the network element communicatively coupled to an adjacent port on an adjacent network element; configuring a maintenance association and port Maintenance End Point (MEP) on the port with the adjacent port on the adjacent network element and using the identified information; exchanging Continuity Check Messages (CCM) over the maintenance association; and detecting a port mismatch between the port and the adjacent port based on CCM-based faults.

### FIELD OF THE DISCLOSURE

The present disclosure generally relates to networking systems and methods. More particularly, the present disclosure relates to link locking systems and methods in Ethernet networks.

### BACKGROUND OF THE DISCLOSURE

In central offices, data centers, etc., various network elements are interconnected via cabling, including through patch panels. The actual process of cabling ports together can be labor intensive and prone to error especially given the number of physical connections in networks. The error possibilities are further increased with the use of intermediate patch panels which are employed for demarcation purposes at network elements. Conventionally, to detect an improper or wrong patch of fibers or cables in a packet data network, operators use Link Layer Discovery Protocol (LLDP) to manually check neighbors or configure Connectivity Fault Management (CFM) port Maintenance End Points (MEPs) manually. Disadvantageously, LLDP-based detection requires manual intervention, i.e., a technician needs to compare the currently learned neighbor with the one that existed previously (e.g., prior to the fiber cut or the like which cause updates to the cabling) and it is prone to human error. The manual configuration of CFM MEPs can be tedious and difficult to implement as a network scales. An external automation entity if designed would thus require exact mapping of all the connections and will have to implement an algorithm to provision CFM. Considering that the network topology may change over time, such an approach would itself be error prone in case the automation entity refers to a network topology which is out-of-date.

### BRIEF SUMMARY OF THE DISCLOSURE

In an embodiment, a method of Ethernet link locking to detect incorrect cabling implemented at a network element includes identifying information using Link Layer Discovery Protocol (LLDP) on a port in the network element communicatively coupled to an adjacent port on an adjacent network element; configuring a maintenance association and a Maintenance End Point (MEP) on the port with the adjacent port on the adjacent network element and using the identified information; exchanging Continuity Check Messages (CCM) over the maintenance association; and detecting a port mismatch between the port and the adjacent port based on CCM-based faults. The identified information can be determined subsequent to a determination the port and the adjacent port are properly connected. The detecting the port mismatch can include a maintenance association trap that does not clear subsequent to maintenance. The MEP can be a port MEP that generates untagged CCMs. The maintenance association can be identified as a combination of the identified information of the port and the network element along with the identified information of the adjacent port and the adjacent network element. The maintenance association can be automatically configured based on the identified information. The method can further include detecting a fault between the port and the adjacent port and a maintenance association fault trap based thereon; and, subsequent to maintenance based on the fault, if the maintenance association fault trap does not clear, determining the port mismatch and raising an associated alarm.

In another embodiment, a network element configured for Ethernet link locking to detect incorrect cabling includes one or more ports configured to switch packets between one another; and a controller configured to identify information using Link Layer Discovery Protocol (LLDP) on a port of the one or more ports communicatively coupled to an adjacent port on an adjacent network element; configure a maintenance association and a Maintenance End Point (MEP) on the port with the adjacent port on the adjacent network element and using the identified information; cause exchange of Continuity Check Messages (CCM) over the maintenance association; and detect a port mismatch between the port and the adjacent port based on CCM-based faults. The identified information can be determined subsequent to a determination the port and the adjacent port are properly connected. The port mismatch can be detected via a maintenance association trap that does not clear subsequent to maintenance. The MEP can be a port MEP that generates untagged CCMs. The maintenance association can be identified as a combination of the identified information of the port and the network element along with the identified information of the adjacent port and the adjacent network element. The maintenance association can be automatically configured based on the identified information. The controller can be further configured to detect a fault between the port and the adjacent port and a maintenance association fault trap based thereon, and, subsequent to maintenance based on the fault, if the maintenance association fault trap does not clear, determine the port mismatch and raise an associated alarm.

In a further embodiment, an apparatus configured for Ethernet link locking to detect incorrect cabling includes circuitry configured to identify information using Link Layer Discovery Protocol (LLDP) on a port of the one or more ports communicatively coupled to an adjacent port on an adjacent network element; circuitry configured to configure a maintenance association and a Maintenance End Point (MEP) on the port with the adjacent port on the adjacent network element and using the identified information; circuitry configured to cause exchange of Continuity Check Messages (CCM) over the maintenance association; and circuitry configured to detect a port mismatch between the port and the adjacent port based on CCM-based faults. The identified information can be determined subsequent to a determination the port and the adjacent port are properly connected. The port mismatch can be detected via a maintenance association trap that does not clear subsequent to maintenance. The MEP can be a port MEP that generates untagged CCMs. The maintenance association can be identified as a combination of the identified information of the port and the network element along with the identified information of the adjacent port and the adjacent network element. The maintenance association can be automatically configured based on the identified information.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a network of two packet switch network elements interconnected to one another via two or more patch panels;

FIG. 2 is a flowchart of a link locking process to detect incorrect cabling implemented at the network element according to the systems and methods described herein;

FIG. 3 is a network diagram of a network of two network elements illustrating various constructs used in the link locking process of FIG. 2 according to the systems and methods described herein;

FIG. 4 is a network diagram of the network of FIG. 1 illustrating a fault between the network elements and the corresponding link down and maintenance association trap raised;

FIG. 5 is a network diagram of the network of FIG. 1 illustrating incorrect cabling between the network elements to address the fault in FIG. 4 and the corresponding link up and maintenance association trap raised;

FIG. 6 is a network diagram of the network of FIG. 1 illustrating correct cabling between the network elements to address the fault in FIG. 4 and the corresponding link up and maintenance association trap cleared; and

FIG. 7 is a block diagram of an example implementation of the network element.

### DETAILED DESCRIPTION OF THE DISCLOSURE

The present disclosure relates to link locking systems and methods in networks, for example Ethernet networks. In particular, link locking means a network administrator, operator, technician, etc. can lock a port to the intended cable connection. Once a link is locked to an intended neighbor, any subsequent wrong patching (or fiber movement) is automatically detected and reported for correction. The link locking systems and methods uses LLDP neighbor information initially for provisioning CFM Port MEPs, i.e., to “lock” the link to a neighbor. For detection of wrong patching (or fiber movement), the systems and methods rely on CFM Port MEP fault notifications. Thus, the systems and methods remove the need for manually checking the LLDP neighbors as it provides an automated detection process. It is highly scalable as the operator has to enable it one time after ensuring that the fibers are correctly patched, i.e., to lock the link. Thereafter, the link locking feature auto-configures neighbor ports for detection of wrong patching (or fiber movement). Also, the systems and methods can be selectively enabled/disabled when there is a need to change the network topology.

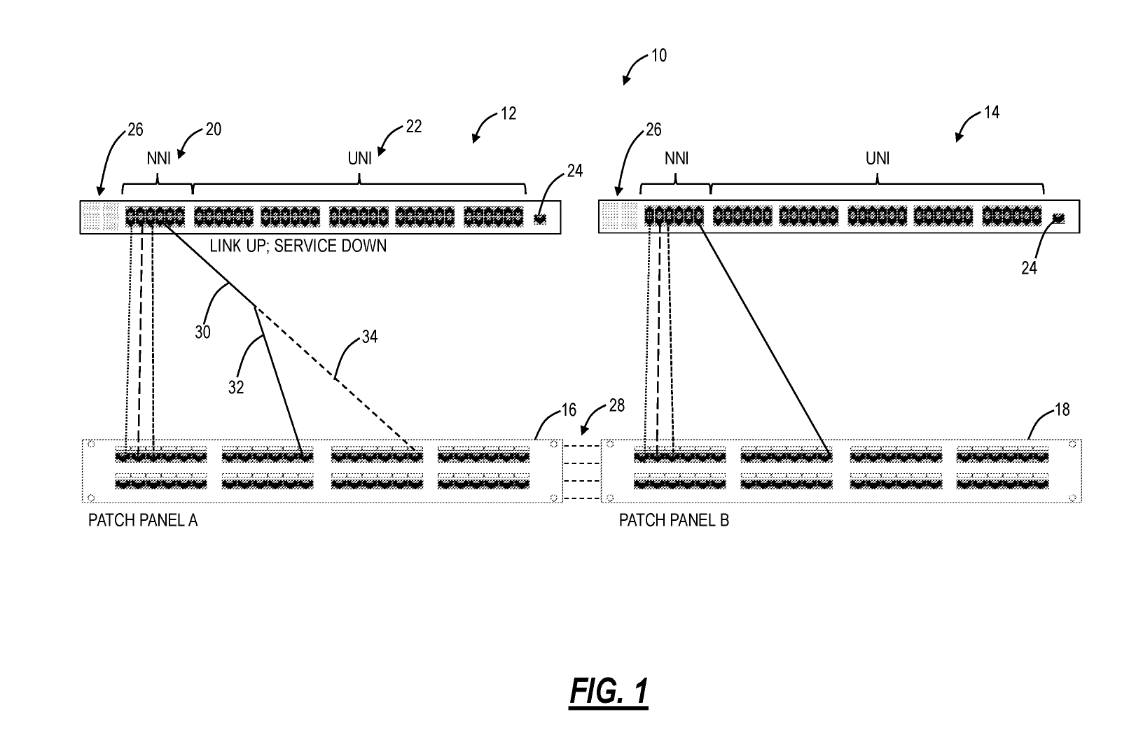

FIG. 1 is a network diagram of a network 10 of two packet switch network elements 12, 14 interconnected to one another via patch panels 16, 18. FIG. 1 illustrates a scenario where although a physical Ethernet link is up, however the services are down due to wrong patching. The network elements 12, 14 include a plurality of Network-Network Interface (NNI) ports 20 and User-Network Interface (UNI) ports 22 which can be physical ports which support cabling, such as via optical fiber. The network elements 12, 14 can also include a management port 24 for local Operations, Administration, Maintenance, and Provisioning (OAM&P) and a plurality of link indicators 26. Of course, the network elements 12, 14 can be accessed remotely for OAM&P. The plurality of link indicators 26 can be Light Emitting Diodes (LEDs) or the like to simply indicate a physical link state, e.g., green=link up, red=link down. The ports 20, 22 can be various types of Ethernet, e.g., 10/100/1000, etc. The network elements 12, 14 can be cabled to the patch panels 16, 18, respectively. For example, the network elements 12, 14 can be at different locations with some transport layer 28 (only schematically shown) between the network elements 12, 14. Those skilled in the art will recognize the ports 20, 22 and cabling thereto can use any technology, and for illustration purposes, it is assumed the cabling is fiber cabling.

Despite best-efforts to physically protect fibers, fiber cuts and the like in real networks are inevitable. In case of a fiber cut, a technician has to visit the site and perform maintenance, such as replacing the damaged fiber, splicing the damaged fiber, etc. During this maintenance process, wrong patching or improper cabling can occur. Note, typically traffic runs on a backup path after a fault, and during the maintenance process, thus the technician cannot validate whether patching is right or wrong. The port can come up even if wrong patching has been done. For example, in FIG. 1, during a maintenance process, a cable 30 connected to an NNI port 20 is in a wrong location on the patch panel 16, e.g., the cable 30 is input as shown by a solid line 32, but should be connected as shown by a dashed line 34. Of note, the link indicator 26 for the port connected to the cable 30 shows green as the link is physically up, but it is connected to the wrong port on the patch panel 16. That is, the link indicators 26 provide verification that a connection exists, not that the correct connection exists. Incorrect patching can occur for various reasons including improper labeling, human error, etc.

While on site, the technician may not be aware that the cable 30 is incorrectly connected to the patch panel 16 and the technician may leave the site of the network element 12. Also, any additional fault in a backup path could cause a complete traffic hit as could a switch back to the primary path with the cable 30 incorrectly connected.

The impact of wrong patching is much more pronounced in scaled networks where a large number of ports are active, and there is a corresponding increased probability of patching a fiber to a wrong port. Debugging wrong connections is also tedious in scaled networks.

As mentioned herein, one approach to addressing this problem is manual debugging either using LLDP neighbor information or pinging the next hop to verify that re-patching is done correctly. This procedure is cumbersome and prone to human error as well. Most of the times the error is caught when traffic switches to a wrongly patched backup path, which causes a complete traffic hit.

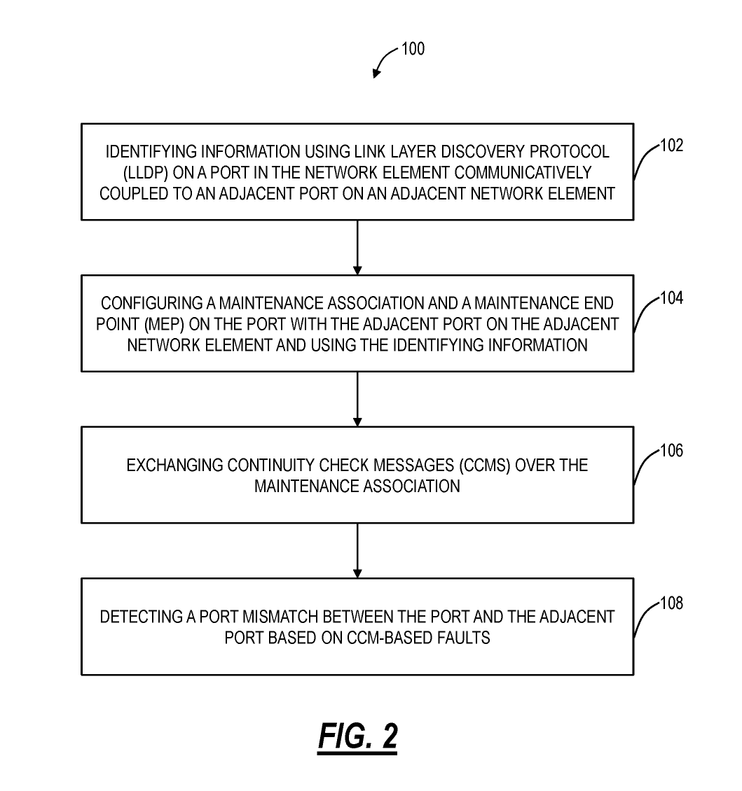

FIG. 2 is a flowchart of a link locking process 100 to detect incorrect cabling implemented at the network element 12, 14 according to the systems and methods described herein. The link locking process 100 can be implemented by the network element 12 in communication with the network element 14 or the like. The link locking process 100 provides an ability to lock a link with the other end of the link automatically. This feature can be configurable per port and can be selectively disabled/enabled. Once link locking is enabled, the link can learn its other end, and thereafter if wrong patching happens, it can notify the user. The link locking process 100 can address wrong patching by immediately raising the alarm as soon as a fiber, cable, etc. is patched incorrectly.

The link locking process 100 includes identifying information using Link Layer Discovery Protocol (LLDP) on a port in the network element communicatively coupled to an adjacent port on an adjacent network element (102); configuring a maintenance association and a Maintenance End Point (MEP) on the port with the adjacent port on the adjacent network element and using the identified information (104); exchanging Continuity Check Messages (CCM) over the maintenance association (106); and detecting a port mismatch between the port and the adjacent port based on CCM-based faults (108).

Specifically, the link locking process 100 uses IEEE 802.1ab LLDP and IEEE 802.1ag Connectivity Fault Management protocols. LLDP is used to provide the identified information subsequent to a determination that the port and the adjacent port are properly connected. That is, once it is known the cabling is proper, LLDP is used to gather the identified information both locally (the port and the network element) and remotely (the adjacent port and the adjacent network element). Of note, the maintenance association is configured at each of the network element and the adjacent network element automatically using a predetermined process based on the identified information.

Once the maintenance association is configured, each network element 12, 14 can listen to maintenance association fault traps being set or cleared such as during recovery of a faulty link to determine whether proper patching has been done. For example, the port mismatch can be detected as a maintenance association trap that does not clear subsequent to maintenance.

With LLDP enabled on neighboring ports, both ends are able to discover each other. The maintenance association is automatically configured between the neighboring ports based on the identified information. The maintenance association can be identified as a combination of the identified information of the port and the network element along with the identified information of the adjacent port and the adjacent network element. As Maintenance association name has to be identical at both ends of the link, both ends of the link would be employing the same algorithm. For example, the maintenance association can be based using the initial 8 characters of the local and remote “Chassis ID” and “Port ID” Type-Length-Value (TLVs). Also, a Port MEP can be created on the port and the adjacent port. Port MEPs are similar to Down MEPs, but they generate untagged CCMs. Specifically, port MEPs are special Down MEPs at level zero (0) used to detect faults at the link level (rather than at service level). The recommendation is to use CCM interval 1 second at both the ends. However, it is not limited to any specific CCM periodicity provided both ends are transmitting at same interval

For example, the maintenance association name can be based on a comparison of the Chassis ID of the local node (network element) and the remote node (adjacent network element). The maintenance association name can be ChassisA PortA ChassisB PortB, where ChassisA is the first eight characters extracted out of the chassis ID which is lower in string comparison between the local and remote node and ChassisB are the first eight characters extracted out of the chassis ID which is higher in string comparison. PortA is the port on ChassisA and PortB is the port on ChassisB. In case the Chassis ID or Port ID TLV happens to be less than eight characters, this approach can use the actual TLV. As MEP ID of local endpoint has to be distinct at two ends of the link, the local MEP ID determination would be done using same algorithm at both ends of the link. For example, the local MEP ID of the chassis having a lower Chassis ID value (numeric/string comparison) can be one, and the local MEP ID of the chassis having higher Chassis ID value can be two.

Of course, other embodiments are also contemplated such as more or fewer characters, a different combination of the Chassis ID or Port ID. It is desired to automatically configure the maintenance association without user intervention to aid in the process of detecting a port mismatch.

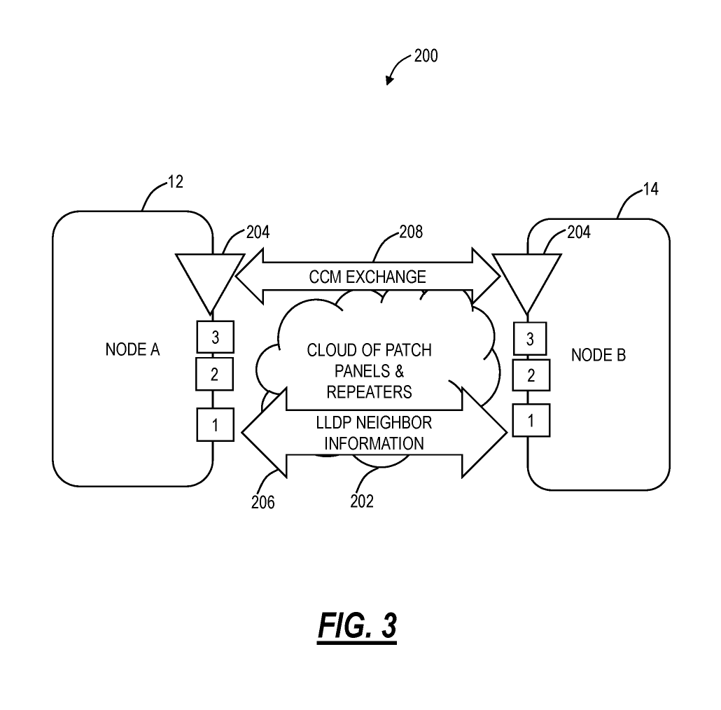

FIG. 3 is a network diagram of a network 200 of two network elements 12, 14 illustrating various constructs used in the link locking process 100 according to the systems and methods described herein. In this example, assume port 3 on the network element 12 is connected to port 1 on the network element 14 via various intermediate devices 202 (represented by a cloud). Again, the intermediate devices can include the patch panels 16, 18, repeaters, optical networking equipment, etc. LLDP neighbor information 206 is exchanged between port 3 on the network element 12 and port 1 on the network element 14 once an operator, technician, installer, etc. notes the cabling is proper. Note, this step is performed to initiate the link locking process 100 and requires the knowledge the cabling is proper. This can be performed subsequent to installation, testing, provisioning, etc.

For example, assume the LLDP neighbor information shows that the network element 12 has a Chassis ID 2C39C1FE9CA0 and the network element 14 has a Chassis ID 2C39C1FE9C70. A comparison of local and remote chassis IDs reveals that the network element 14 has a lower value. So, the name of maintenance association pair would thus be C1FE9C70_1_C1FE9CA0_3. With the LLDP neighbor information, i.e., the identified information, each of the network elements 12, 14 establish port MEPs 204 and a maintenance association which includes an exchange of CCM 208. Once the maintenance association comes up with both ends discovering the port MEPs 204 and exchanging CCMs, each MEP 204 tracks incoming CCMs. If three consecutive CCMs are not received, the MEP 204 can send a Simple Network Management Protocol (SNMP) fault trap to alert the network operator.

The link locking process 100 can further include detecting a fault between the port and the adjacent port and a maintenance association fault trap based thereon, and, subsequent to maintenance based on the fault, if the maintenance association fault trap does not clear, determining the port mismatch and raising an associated alarm. For example, the fault can be in the intermediate devices 202, and there can be re-cabling based thereon.

For example, whenever there is a fiber cut or other fault, each MEP 204 can report a maintenance association fault trap such as via SNMP. Assume a technician visits the field location and performs maintenance, the technician can validate whether the patching is correct using SNMP traps. That is if the link comes up and maintenance association fault is set, it means it is wrong patching, or if the link comes up and maintenance association fault clear trap comes, it indicates that correct patching has been done.

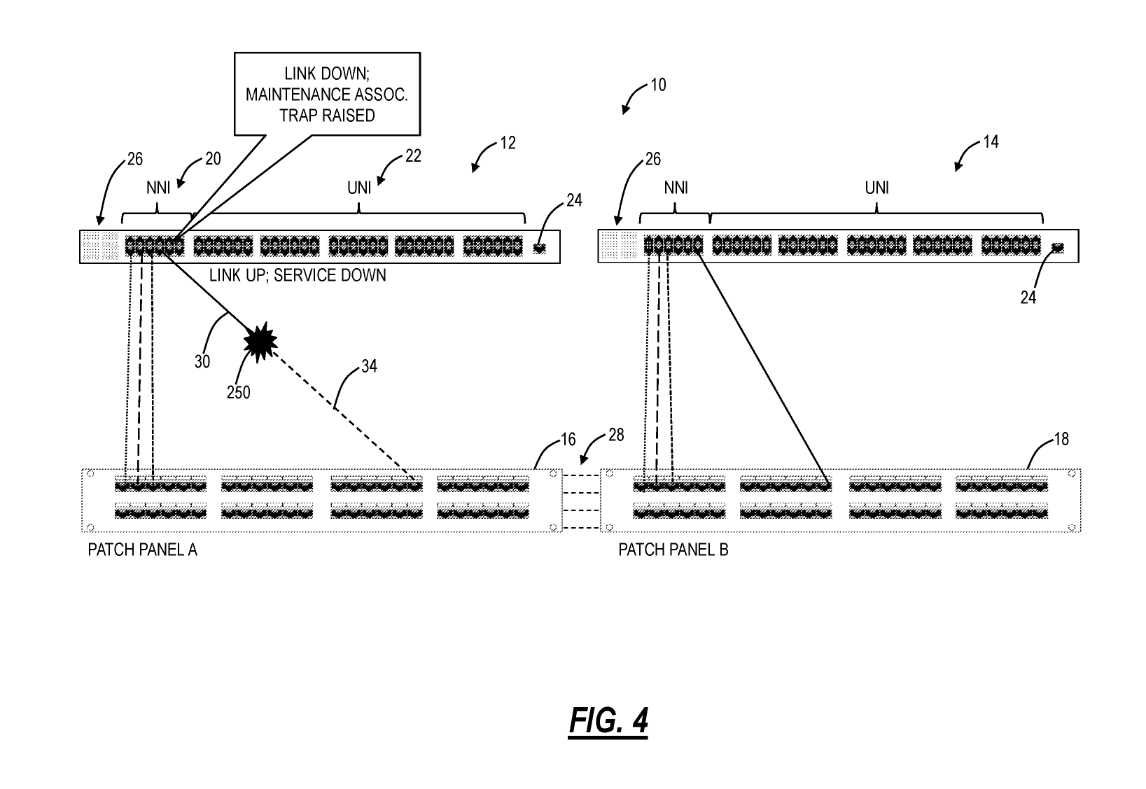

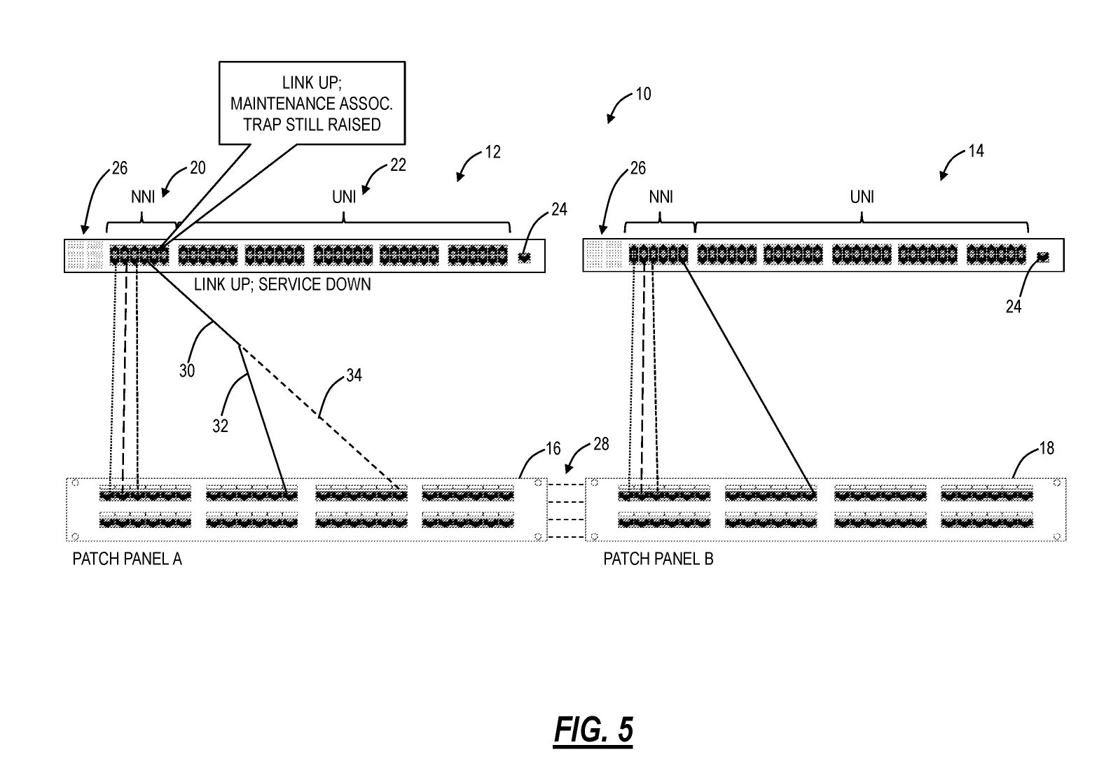

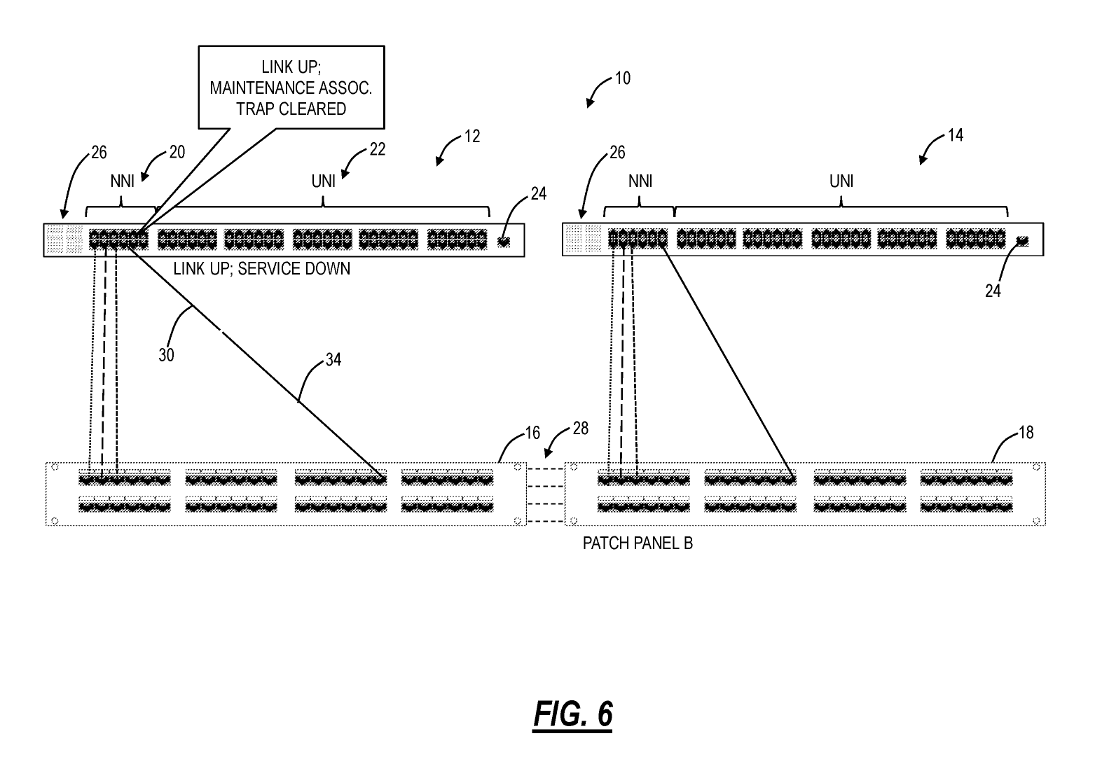

FIGS. 4-6 are network diagrams of the network 10 of two packet switch network elements 12, 14 interconnected to one another via patch panels 16, 18 illustrating the link locking process 100. FIG. 4 is a network diagram of the network 10 illustrating a fault 250 between the network elements 12, 14 and the corresponding link down and maintenance association trap raised. FIG. 5 is a network diagram of the network 10 illustrating incorrect cabling between the network elements 12, 14 to address the fault 250 and the corresponding link up and maintenance association trap raised. FIG. 6 is a network diagram of the network 10 illustrating correct cabling between the network elements 12, 14 to address the fault 250 and the corresponding link up and maintenance association trap cleared.

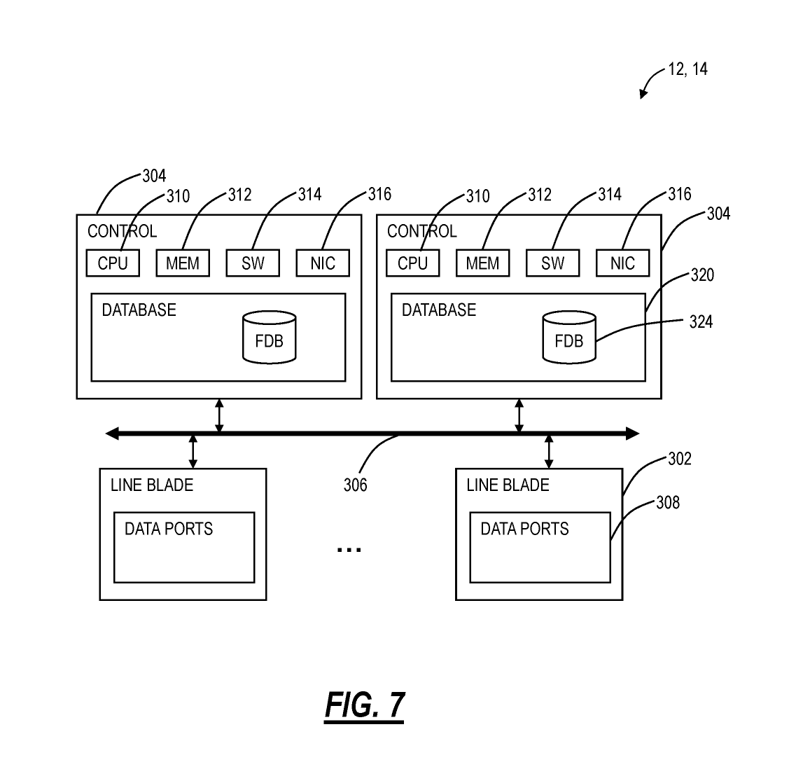

FIG. 7 is a block diagram of an example implementation of the network element 12, 14. For example, the network element 12, 14 is an Ethernet network switch, but those of ordinary skill in the art will recognize other types of network elements and other implementations are contemplated, such as, for example, a layer two switch integrated within an optical network element. The network element 12, 14 can include one or more blades 302, 304 interconnected via an interface 306. The blades 302, 304 are also known as line cards, line modules, circuit packs, pluggable modules, etc. and generally refer to components mounted within a chassis, shelf, etc. of a data switching device, i.e., the network element 12, 14. Alternatively, the functionality of each of the blades 302, 304 may be integrated into a single module such as in a layer two switch integrated within an optical network element. Further, the functionality of each of the blades 302, 304 may be integrated into a single hardware device, such as a pizza box switch. That is, the blades 302, 304 represent functionality and various hardware, and physical implementations may vary.

Each of the blades 302, 304 may include numerous electronic devices and optical devices mounted on a circuit board along with various interconnect including interfaces to the chassis, shelf, etc. Two example blades are illustrated with line blades 302 and control blades 304. The line blades 302 generally include data ports 308 such as a plurality of Ethernet ports. For example, the line blade 302 may include a plurality of physical ports disposed on an exterior of the blade 302 for receiving ingress/egress connections. Additionally, the line blades 302 may include switching components to form a switching fabric via the backplane 306 between all of the data ports 308 allowing data traffic to be switched between the data ports 308 on the various line blades 302. The switching fabric is a combination of hardware, software, firmware, etc. that moves data coming into the network element 12, 14 out by the correct port 308 to the next network element. The switching fabric includes switching units, or individual boxes, in a node; integrated circuits contained in the switching units; and programming that allows switching paths to be controlled.

The control blades 304 include a microprocessor 310, memory 312, software 314, and a network interface 316. Specifically, the microprocessor 310, the memory 312, and the software 314 may collectively control, configure, provision, monitor, etc. the network element 12, 14. The network interface 316 may be utilized to communicate with an element manager, a network management system, etc. Additionally, the control blades 304 may include a database 320 that tracks and maintains provisioning, configuration, operational data and the like. The database 320 may include a forwarding database (FDB) 322. In this example, the network element 12, 14 includes two control blades 304 which may operate in a redundant or protected configuration such as 1:1, 1+1, etc. In general, the control blades 304 maintain dynamic system information including Layer 2 forwarding databases, protocol state machines, and the operational status of the ports 308 within the network element 12, 14. The blades 302, 304 can be configured to implement the link locking process 100.

The network element 12, 14 configured for Ethernet link locking to detect incorrect cabling includes one or more ports 308 configured to switch packets between one another; and a controller 304 configured to identify information using Link Layer Discovery Protocol (LLDP) on a port of the one or more ports communicatively coupled to an adjacent port on an adjacent network element; configure a maintenance association and port Maintenance End Point (MEP) on the port with the adjacent port on the adjacent network element and using the identified information; cause exchange of Continuity Check Messages (CCM) over the maintenance association; and detect a port mismatch between the port and the adjacent port based on the CCM-based faults.

In another embodiment, an apparatus configured for Ethernet link locking to detect incorrect cabling includes circuitry configured to determine identified information using Link Layer Discovery Protocol (LLDP) on a port of the one or more ports communicatively coupled to an adjacent port on an adjacent network element; circuitry configured to configure a maintenance association and port Maintenance End Point (MEP) on the port with the adjacent port on the adjacent network element and using the identified information; circuitry configured to cause exchange of Continuity Check Messages (CCM) over the maintenance association; and circuitry configured to detect a port mismatch between the port and the adjacent port based on the CCMs.

The link locking process 100 can be applicable to Link Aggregation members since the port MEPs 204 can be created on individual aggregation members.

After enabling the link locking process 100, the link locking shall happen with the current LLDP neighbor and thereafter unintended fiber movement shall be reported through the trap/alarm. If a user wants to move the link intentionally, it can be done after disabling the link locking feature on the both ends of the link. Once movement is done, link locking can be enabled to lock the link with a new neighbor.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method of Ethernet link locking to detect incorrect cabling implemented at a network element, the method comprising:
identifying information using Link Layer Discovery Protocol (LLDP) on a port in the network element communicatively coupled to an adjacent port on an adjacent network element;
configuring a maintenance association and a Maintenance End Point (MEP) on the port with the adjacent port on the adjacent network element and using the identified information;
exchanging Continuity Check Messages (CCM) over the maintenance association; and
detecting a port mismatch between the port and the adjacent port based on CCM-based faults.

2. The method of claim 1, wherein the identified information is determined subsequent to a determination the port and the adjacent port are properly connected.

3. The method of claim 1, wherein the detecting the port mismatch comprises a maintenance association trap that does not clear subsequent to maintenance.

4. The method of claim 1, wherein the MEP is a port MEP that generates untagged CCMs.

5. The method of claim 1, wherein the maintenance association is identified as a combination of the identified information of the port and the network element along with the identified information of the adjacent port and the adjacent network element.

6. The method of claim 1, wherein the maintenance association is automatically configured based on the identified information.

7. The method of claim 1, further comprising:
detecting a fault between the port and the adjacent port and a maintenance association fault trap based thereon; and
subsequent to maintenance based on the fault, if the maintenance association fault trap does not clear, determining the port mismatch and raising an associated alarm.

8. A network element configured for Ethernet link locking to detect incorrect cabling, the network element comprising:
one or more ports configured to switch packets between one another; and
a controller configured to
identify information using Link Layer Discovery Protocol (LLDP) on a port of the one or more ports communicatively coupled to an adjacent port on an adjacent network element;
configure a maintenance association and a Maintenance End Point (MEP) on the port with the adjacent port on the adjacent network element and using the identified information;
cause exchange of Continuity Check Messages (CCM) over the maintenance association; and
detect a port mismatch between the port and the adjacent port based on CCM-based faults.

9. The network element of claim 8, wherein the identified information is determined subsequent to a determination the port and the adjacent port are properly connected.

10. The network element of claim 8, wherein the port mismatch is detected via a maintenance association trap that does not clear subsequent to maintenance.

11. The network element of claim 8, wherein the MEP is a port MEP that generates untagged CCMs.

12. The network element of claim 8, wherein the maintenance association is identified as a combination of the identified information of the port and the network element along with the identified information of the adjacent port and the adjacent network element.

13. The network element of claim 8, wherein the maintenance association is automatically configured based on the identified information.

14. The network element of claim 8, wherein the controller is further configured to
detect a fault between the port and the adjacent port and a maintenance association fault trap based thereon, and
subsequent to maintenance based on the fault, if the maintenance association fault trap does not clear, determine the port mismatch and raise an associated alarm.

15. An apparatus configured for Ethernet link locking to detect incorrect cabling, the apparatus comprising:
circuitry configured to identify information using Link Layer Discovery Protocol (LLDP) on a port of the one or more ports communicatively coupled to an adjacent port on an adjacent network element;
circuitry configured to configure a maintenance association and a Maintenance End Point (MEP) on the port with the adjacent port on the adjacent network element and using the identified information;
circuitry configured to cause exchange of Continuity Check Messages (CCM) over the maintenance association; and
circuitry configured to detect a port mismatch between the port and the adjacent port based on CCM-based faults.

16. The apparatus of claim 15, wherein the identified information is determined subsequent to a determination the port and the adjacent port are properly connected.

17. The apparatus of claim 15, wherein the port mismatch is detected via a maintenance association trap that does not clear subsequent to maintenance.

18. The apparatus of claim 15, wherein the MEP is a port MEP that generates untagged CCMs.

19. The apparatus of claim 15, wherein the maintenance association is identified as a combination of the identified information of the port and the network element along with the identified information of the adjacent port and the adjacent network element.

20. The apparatus of claim 15, wherein the maintenance association is automatically configured based on the identified information.
